(19) United States
(12) Patent Application Publication
(10) Pub. No.: US 2025/0053608 A1
(43) Pub. Date: Feb. 13, 2025

(54) METHOD OF OPERATING A MULTI-VARIABLE PROCESS

(71) Applicant: Process Plant Computing Limited, Beaconsfield (GB)

(72) Inventors: Alan Mahoney, Beaconsfield (GB); John Wilson, Beaconsfield (GB); Robin Brooks, Beaconsfield (GB)

(73) Assignee: Process Plant Computing Limited, Beaconsfield (GB)

(21) Appl. No.: 18/789,887

(22) Filed: Jul. 31, 2024

(30) Foreign Application Priority Data
Aug. 7, 2023 (GB) 2312082.7

(51) Int. Cl. G06F 17/10

(52) U.S. Cl. CPC G06F 17/10

(57) ABSTRACT

A method of operating a multi-variable process comprises deriving a multi-dimensional representation of the process variables according to individual co-ordinate axes, defining a feasible region of the process variables by selecting from an accumulation of historical sets of values of all the variables, obtained from multiple operations of the process, to define an operational envelope containing a set of data points for which the product qualities are within predetermined limits, calculating the convex hull of this set of data points, determining an interior hypercube inside the convex hull, the interior hypercube having sides that are parallel to each axis, and then operating the process with the process variables as defined within the interior hypercube.

### RELATED APPLICATIONS

This application claims the priority of UK application GB 2312082.7, which was filed on Aug. 7, 2023, and which is herein incorporated by reference in its entirety for all purposes.

### FIELD OF THE INVENTION

This invention relates to a method of operating a multi-variable process.

### BACKGROUND OF THE INVENTION

GB2363647A, GB2378527A, GB2391085A, GB2405706A and GB2453035, all of which are incorporated herein by reference in their entirety for all purposes, describe aspects of a system of a general type in which a multidimensional display representation of the variables of a process—flows, temperatures, product qualities, for example—is derived according to individual, parallel or other spaced co-ordinate axes. Within this multi-dimensional space, the Best Operating Zone (BOZ) can be defined from historical operating data. This is the region of the multi-dimensional space defined by the operating variables that is considered satisfactory; that is, for every operating point in the BOZ, all the variables, both process variables and quality variables, have values that meet all criteria. The system calculates the Convex Hull of the BOZ and derives dynamic optimal control of the process from that basis.

In all the described implementations of this system, control is dynamic—the permissible range on each variable depends in general on the value of some of the other variables. In some processes, for example pharmaceutical manufacturing processes, there is a need to be able to set ranges on the process variables such that, so long as the value of each variable is somewhere within its range, operation will be satisfactory, so that each variable can be controlled independently of the others. A pharmaceutical process needs to be licensed to confirm that the product of the process will always have qualities within specified limits. The definition of the process includes operating variables such as residency in reaction vessels, temperatures and pressures, and proportions of the various ingredients in the feedstock. There is some unavoidable variation in each of these and the process owner needs to know a range for each variable such that the product is certain to be in-specification if each variable is in range.

### SUMMARY OF THE INVENTION

According to the invention, a method of operating a multi-variable process comprises deriving a multi-dimensional representation of the process variables according to individual co-ordinate axes, defining a feasible region of the process variables by selecting from an accumulation of historical sets of values of all the variables, obtained from multiple operations of the process, to define an operational envelope containing a set of data points for which the product qualities are within predetermined limits, calculating the convex hull of this set of data points, and then determining an interior hypercube inside the convex hull, the interior hypercube having sides that are parallel to each axis, and then operating the process with the process variables as defined within the interior hypercube.

A method according to one embodiment includes the further step of calculating the maximal interior hypercube. The further step may comprise maximising the length of the shortest side of the hypercube. This may be done by:
a) identifying the shortest side of the hypercube;
b) calculating from the geometry of the set of convex hulls the coefficient of the length of the shortest side with respect to the value of each process variable in the hypercube and the range of values of that process variable for which the coefficient is valid;
c) moving the value with the largest coefficient to a point where either the coefficient is no longer valid or the side being increased is no longer the shortest side; and
d) repeating steps (a) to (c) until no further improvement is possible.

Provided the data from which the model is built is adequate, then operating in accordance with the invention will keep the process in a region for which in historical data the product has always been within specification.

The present invention is a method of operating a multi-variable process. The method includes deriving a multi-dimensional representation of the process variables according to individual co-ordinate axes, defining a feasible region of the process variables by selecting from an accumulation of historical sets of values of all the variables, obtained from multiple operations of the process, to define an operational envelope containing a set of data points for which the product qualities are within predetermined limits, calculating the convex hull of this set of data points, determining an interior hypercube inside the convex hull, the interior hypercube having sides that are parallel to each axis, and operating the process with the process variables as defined within the interior hypercube.

In embodiments, the interior hypercube is a maximal interior hypercube. In some of these embodiments calculating the maximal interior hypercube comprises maximizing a length of a shortest side of the interior hypercube. In some of these embodiments, calculating the maximal interior hypercube includes:
a) selecting as a selected side of the interior hypercube the shortest side of the interior hypercube;
b) for each process variable in the interior hypercube, calculating, from a geometry of a set of convex hulls, an associated coefficient of the length of the selected side with respect to that process variable and calculating a range of values of that process variable for which the associated coefficient is valid;
c) selecting as a selected coefficient and selected process variable a largest of the coefficients of the length of the selected side and its associated process variable;
d) increasing the selected side of the interior hypercube by adjusting a value of the selected process variable until either the selected coefficient is no longer valid or the selected side is no longer the shortest side of the interior hypercube; and
e) repeating steps (a) to (d) until the length of the shortest side of the interior hypercube cannot be further increased.

In any of the above embodiments, the process can be a pharmaceutical manufacturing process.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 shows a dataset in parallel co-ordinates, with one datapoint selected;

FIG. 2 shows a selection from the dataset;

FIG. 3 is a display of limits due to convex hull and to the Inner Hypercube; and

FIG. 4 is an example of the Inner Rectangle of a 2-D Convex Hull, illustrating one way of calculating the Inner Hypercube.

### DETAILED DESCRIPTION

For an industrial process such as a pharmaceutical manufacturing process, data consisting of process variable values and product quality is collected in the laboratory or on a pilot plant, for a range of values wider than that envisioned for actual operation. Data points for which the product qualities are in-specification are selected. Using the method set out in GB2363647A, GB2378527A and GB2453035A, the Convex Hull of this set of data points is calculated. The Convex Hull of the set of datapoints used is the smallest closed convex figure in the multi-dimensional space defined by the variables that encloses all the datapoints in the set. In general, some approximation to this figure will be used. In the current implementation of the method, the intersection of the 2-dimensional Convex Hulls between all pairs of variables has been used.

Then an Interior Hypercube (IHC) inside the convex hull is found. The IHC has sides (that are not in general of equal length) parallel to each axis. According to the invention the maximal IHC is found. More than one definition of the maximal IHC is possible: a sensible criterion such as maximizing the length of the shortest side, perhaps weighted for the variables' controllability properties, can be used. The IHC may be required to include given values for any of the process variables if required.

The IHC gives limits on the process variables that ensure that the process operation will be within the convex region for which historically the product has always been in-specification, and also gives limits on the product qualities which in general will be narrower than those of the specification. It may be worthwhile to offer these tighter limits as a tighter specification in some cases.

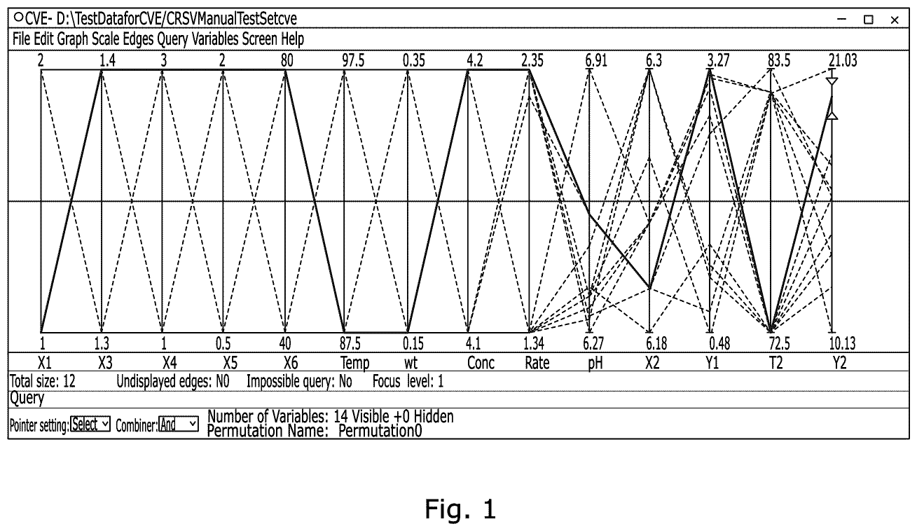

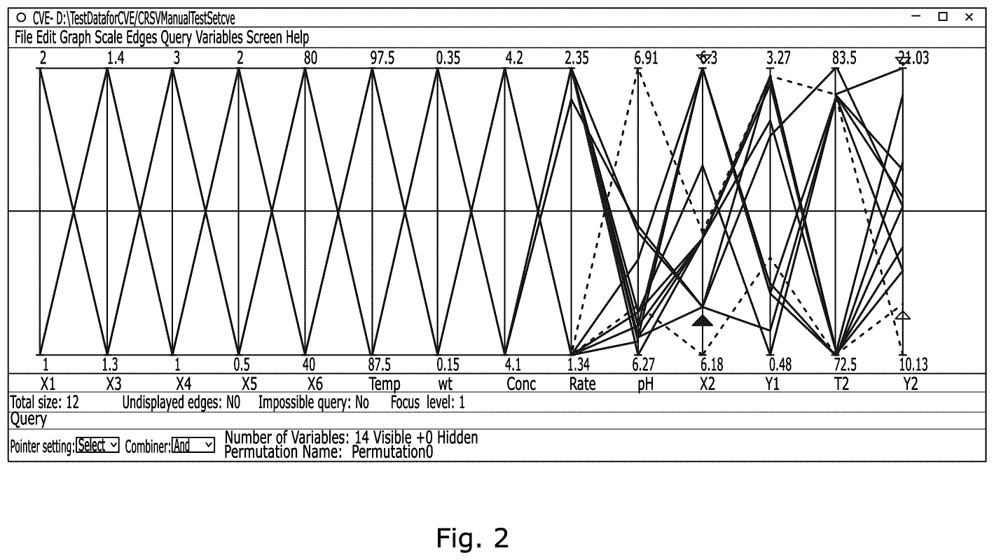

FIG. 1 is a display of a small dataset of 14 variables and 12 sets of values. Each variable has a vertical axis. A single data point is represented by a polyline connecting the values of each of the variables for that point. A single data point is selected and shown as a chain-dotted line. For this example, the first 9 variables are assumed to be process variables and the last 5 are product qualities. Suppose this dataset is mostly OK but the lowest values of X2 and Y2 are not acceptable. So, a Query is created that excludes these values. FIG. 2 illustrates the selected 10-row dataset. In FIG. 2, the two unselected datapoints are shown as chain-dotted lines.

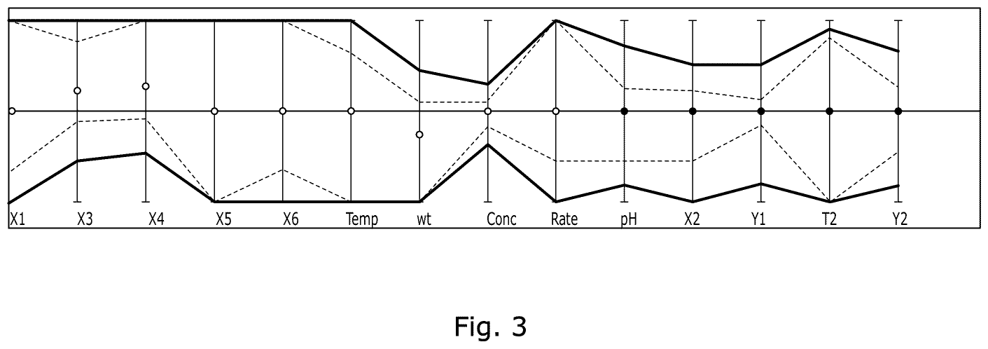

The convex hull of the 10 datapoints in the 14 dimensions is calculated. The limits are then calculated on each variable to remain inside the convex hull while all other variables that are fixed remain at their Fixed Values; and working values of unfixed variables may optionally also set limits. This is in accordance with the method described in GB2363647A. An Inner Hypercube (IHC) of the convex hull is then calculated. So long as the datapoint is within the IHC, the value of any variable can be moved to any value within the ends of its side of the IHC without affecting the IHC limits on any other variable. FIG. 3 displays the results of these calculations. Fixed Values of variables are indicated by filled circles on their axes, and Working Values by open circles. The upper and lower heavy polylines connect the upper and the lower limits respectively on the variables due to the convex hull. The upper dotted polyline connects the upper limits on the variables due to the IHC, and the lower dotted polyline the lower limits. The range between values where the upper and lower dotted lines meet the axis of a variable is the side of the IHC for that variable.

The calculation of the Inner Hypercube may be carried out using a method of the general type described in the following example. It should be noted that the sides of the Inner Hypercube are not in general equal, so a 3-dimensional hypercube is not necessarily a cube. There are a number of process variables. A datapoint consists of a value for each process variable. A dataset is a set of datapoints. The dataset is selected so that when the process variables have the values of any datapoint in the dataset the quality variables are all in-specification. It is necessary to find the Inner Hypercube of the Convex Hull of this dataset. It is not generally feasible to calculate the exact Convex Hull of a dataset of more than 8 variables so it is approximated by the set of 2-dimensional Convex Hulls of the projections of the dataset into the space of every pair of variables.

Starting from a point in which every process variable is set to a value that is required to be within the IHC, the maximum values are then increased and the minimum values decreased by the same small increment until the values of a pair of variables go outside their 2-D convex hull. If there is no required value, the default starting point is the mid-point of its range in the dataset; this midpoint value is both the starting maximum value and the starting minimum value of the variable. The values of the variables are cut back to the intersection of the incremental step with the edge of the convex hull, and these are the upper or lower limits on the values, as the case may be. But as all the 2-D convex hulls are checked in turn a later hull may place a lower upper limit or higher lower limit on a variable than a hull already checked. Then returning to the original hull the more restricted limit on one of the variables may allow one of the limits on the other variable to be moved outwards. In due course this process gives a set of upper and lower limits on all the variables in which no upper limit can be increased or lower limit decreased without violating one of the 2-D convex hulls. These limits taken in every combination of uppers and lowers on all the variables are the corners of the Inner Hypercube.

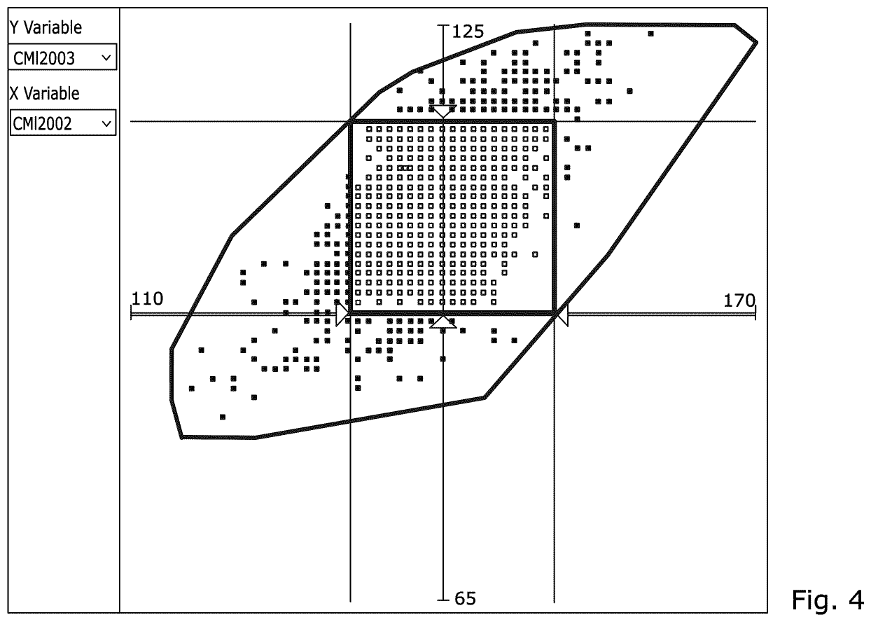

An example of the calculation of the Inner Hypercube is illustrated by FIG. 4, which shows the Inner Rectangle of a 2-D Convex Hull. The Inner Hypercube calculated from any starting point P0 gives a set of ranges on all the process variables such that qualities will be in-spec so long as every process variable is within its range. But the Inner Hypercube will in general not be the same if a different starting point is used. All such hypercubes are valid, so it is possible and desirable to find the best such hypercube. The criterion for the best inner hypercube is the length of its shortest side, i.e. the most restrictive range on any process variable. An optimization is performed over the elements of P0 to maximize the length of the shortest side. The optimization process is an iteration of 3 steps:
Identify the shortest side of the inner hypercube;
Calculate, from the geometry of the set of Convex Hulls, the coefficient of the length of the shortest side with respect to the value of each process variable in P0, and the range of values of that process variable for which the coefficient is valid; and
Move the value with the largest coefficient to a point where either the coefficient is no longer valid, or the side being increased is no longer the shortest side.

This is continued until no further improvement is possible, resulting in the maximal inner hypercube.

It is possible that there may be a number of distinct operating regions (sets of values of the process variables) that seem equally good. In that case, the user might try finding the maximal IHC for each such operating region and then choose the one with the largest IHC, because it is the most easily controllable.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A method of operating a multi-variable process, the method comprising:
deriving a multi-dimensional representation of the process variables according to individual co-ordinate axes;
defining a feasible region of the process variables by selecting from an accumulation of historical sets of values of all the variables, obtained from multiple operations of the process, to define an operational envelope containing a set of data points for which the product qualities are within predetermined limits;
calculating the convex hull of this set of data points;
determining an interior hypercube inside the convex hull, the interior hypercube having sides that are parallel to each axis; and
operating the process with the process variables as defined within the interior hypercube.

2. The method of claim 1, wherein the interior hypercube is a maximal interior hypercube.

3. The method of claim 2, wherein calculating the maximal interior hypercube comprises maximizing a length of a shortest side of the interior hypercube.

4. The method of claim 3, wherein calculating the maximal interior hypercube comprises:
a. selecting as a selected side of the interior hypercube the shortest side of the interior hypercube;
b. for each process variable in the interior hypercube, calculating, from a geometry of a set of convex hulls, an associated coefficient of the length of the selected side with respect to that process variable and calculating a range of values of that process variable for which the associated coefficient is valid;
c. selecting as a selected coefficient and selected process variable a largest of the coefficients of the length of the selected side and its associated process variable;
d. increasing the selected side of the interior hypercube by adjusting a value of the selected process variable until either the selected coefficient is no longer valid or the selected side is no longer the shortest side of the interior hypercube; and
e. repeating steps (a) to (d) until the length of the shortest side of the interior hypercube cannot be further increased.

5. The method of claim 1, wherein the process is a pharmaceutical manufacturing process.
